(19) United States
(12) Patent Application Publication
(10) Pub. No.: US 2011/0181506 A1
(43) Pub. Date: Jul. 28, 2011

(54) OPTICAL POINTING DEVICE

(76) Inventor: HUNG-TE LEE, Taipei (TW)

(21) Appl. No.: 12/775,610

(22) Filed: May 7, 2010

(30) Foreign Application Priority Data
Jan. 25, 2010 (TW) 099101943

(51) Int. Cl. G09G 5/08

(52) U.S. Cl. 345/157

(57) ABSTRACT

An optical pointing device includes a circuit board, a light emitting component, a detection unit, a light guiding component, an imaging lens, and a transparent touch platform. The light emitting component is disposed on and connected electrically to the circuit board. The detection unit is disposed on and connected electrically to the circuit board, and is spaced part from the light emitting component. The light guiding component is adjacent to the light emitting component, and includes a concave reflective mirror. The imaging lens is disposed above the detection unit. The transparent touch platform is disposed above the imaging lens and has a touch surface for movement of an object under detection thereon.

### CROSS-REFERENCE TO RELATED APPLICATION

This application claims priority of Taiwanese Application No. 099101943, filed on Jan. 25, 2010, the disclosure of which is hereby incorporated by reference.

### BACKGROUND OF THE INVENTION

1. Field of the Invention

The present invention relates to a pointing device, more particularly to an optical pointing device.

2. Description of the Related Art

A conventional electronic device, such as a cell phone, a computer, etc., has a display screen, and a pointing device is controlled by a user to operate the electronic device through the display screen. Conventional pointing devices can be classified into an optical type (e.g., an optical mouse) and a mechanical type (e.g., a wheel mouse, a joystick, a track ball, a direction key, etc). Compared to the mechanical pointing device, the optical pointing device does not have the issues of mechanical abrasion and dust accumulation in the mechanisms. Therefore, the optical mouse has been adopted widely for computer systems and other electronic devices. However, the optical mouse is large and so is not convenient for a user to carry.

U.S. Pat. No. 6,057,540 discloses a mouseless, optical and motion translation type screen pointer control mechanism, which includes a rod lens, and a light source and a sensor both of which are disposed proximate the distal end of the rod lens. An isolating component is disposed between the light source and the sensor for preventing light emitted from the light source from being delivered directly to the sensor. A top surface of the rod lens is used for movement of a finger thereon.

The light emitted from the light source is directed to the finger through the rods lens, and is then reflected by the finger to reach the sensor through the rod lens. The sensor receives a moving image of the finger and determines a displacement distance and a displacement direction.

Although this mechanism can be integrated in a keyboard, the rod lens must be made to at least a predetermined height, such that this conventional pointer control mechanism is unsuitable for use in miniaturized devices. In addition, stray light, which is generated when the light is reflected inside the rod lens, reaches the sensor easily so that noise will be produced.

### SUMMARY OF THE INVENTION

Therefore, the object of the present invention is to provide an optical pointing device which can be reduced in size and which saves electrical power.

Accordingly, an optical pointing device of the present invention comprises a circuit board, a light emitting component, a detection unit, a light guiding component, an imaging lens, and a transparent touch platform.

The light emitting component is disposed on and connected electrically to the circuit board.

The detection unit is disposed on and connected electrically to the circuit board, and is spaced part from the light emitting component.

The light guiding component is adjacent to the light emitting component, and includes a concave reflective mirror.

The imaging lens is disposed above the detection unit. The transparent touch platform is disposed above the imaging lens and has a touch surface for movement of an object under detection thereon.

Light emitted from the light emitting component is reflected by the concave reflective mirror to pass through the transparent touch platform, and is then reflected by the object under detection to again pass through the transparent touch platform and further through the imaging lens, after which the light reflected by the object under detection is projected onto the detection unit. The detection unit determines a displacement distance and direction of the object under detection relative to the touch surface of the transparent touch platform.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of an optical pointing device according to a preferred embodiment of the present invention;

FIG. 2 is a top view of the optical pointing device of the preferred embodiment;

FIG. 3 is a sectional view of the optical pointing device of the preferred embodiment taken along line in FIG. 2;

FIG. 4 is a schematic view of the optical pointing device of the preferred embodiment to illustrate the operating principle thereof; and

FIG. 5 is a schematic view of the optical pointing device of the preferred embodiment to illustrate a concave reflective mirror including a plurality of small concave mirrors which are assembled together to form a mirror array.

### DETAILED DESCRIPTION OF THE PREFERRED EMBODIMENT

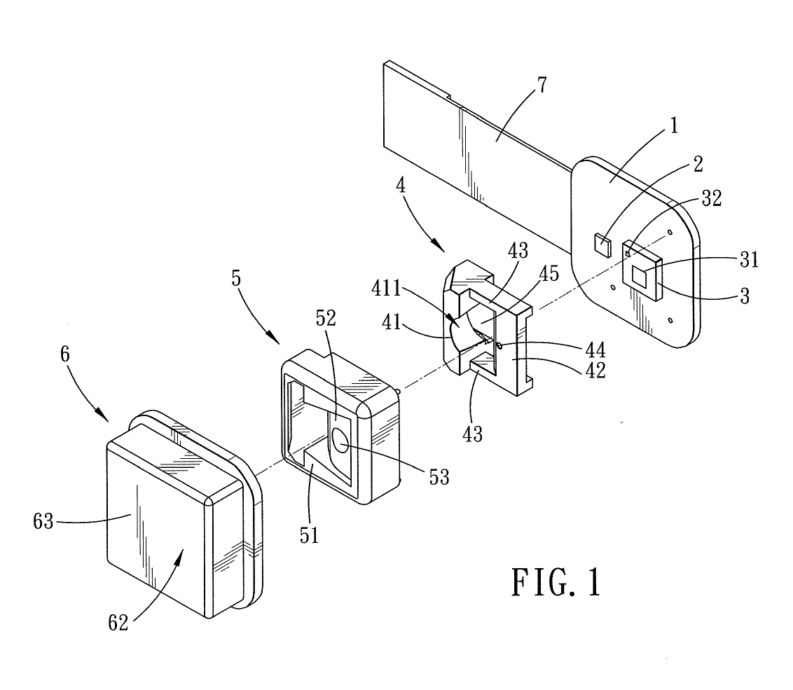

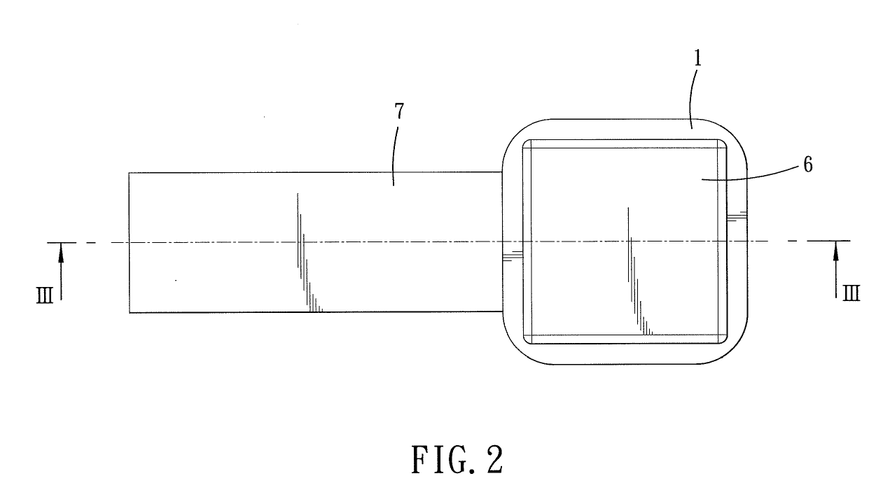

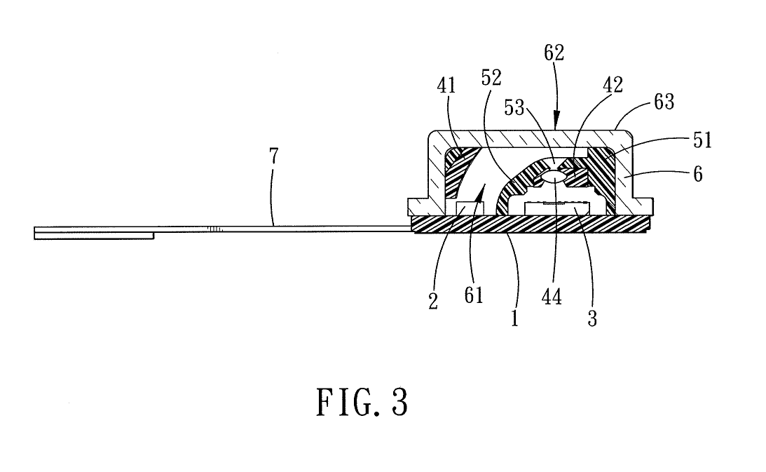

Referring to FIGS. 1, 2, and 3, a preferred embodiment of an optical pointing device according to the present invention is shown to comprise a circuit board 1, a light emitting component 2, a detection unit 3, an inner framework 4, an outer framework 5, an outer cover 6, and a flexible printed circuit board 7.

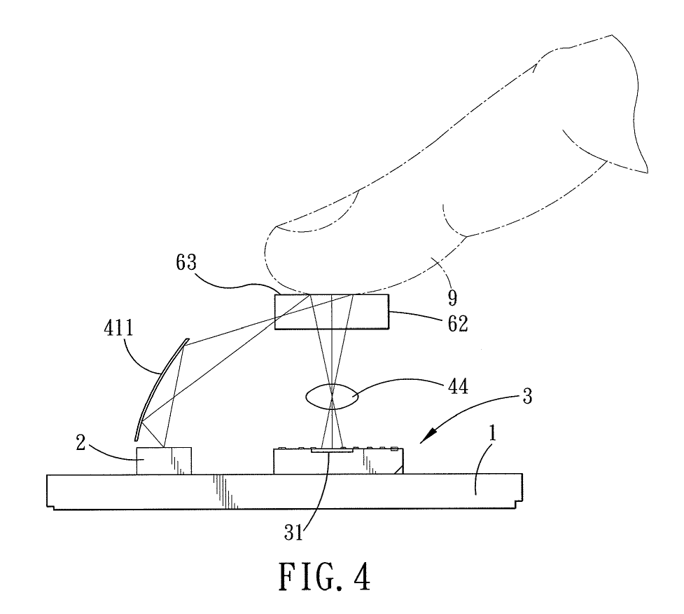

The light emitting component 2 is disposed on and connected electrically to the circuit board 1 for providing a light source to illuminate an object under detection 9 (e.g., a finger or a stylus), as shown in FIG. 4. In this embodiment, the light emitting component 2 includes a light emitting diode (LED) or a laser diode (LD).

The detection unit 3 is disposed on and connected electrically to the circuit board 1, and is spaced part from the light emitting component 2. The detection unit 3 includes an image sensor 31 and a displacement calculation circuit 32. In this embodiment, the image sensor 31 includes a charge coupled device (CCD) sensor or a complementary metal-oxide-semiconductor (CMOS) sensor.

The inner framework 4 includes a light guiding component 41, a support 42, a connecting arm 43, and an imaging lens 44. The light guiding component 41 is adjacent to the light emitting component 2 and includes a concave reflective mirror 411. The connecting arm 43 interconnects the light guiding component 41 and the support 42 in such a manner that a gap 45 is formed therebetween for passage of the light reflected by the concave reflective mirror 411 of the light guiding component 41 toward the outer cover 6. The support 42 holds the imaging lens 44, and is above the detection unit 3. The imaging lens 44 is disposed above the detection unit 3. The gap 45 is defined by the support 42, the connecting arm 43, and the light guiding component 41.

In some embodiments, the inner framework 4 includes a pair of connecting arms 43. The connecting arms 43 extend from two opposite sides of the support 42 and are connected to the light guiding component 41. In this case, the gap 45 is defined by the support 42, the pair of the connecting arms 43, and the light guiding component 41.

The outer framework 5 includes an opaque isolating portion 52 and a frame body portion 51. The opaque isolating portion 52 is disposed between the light emitting component 2 and the detection unit 3 for preventing light emitted from the light emitting component 2 from being delivered directly to the detection unit 3, which can avoid noise effectively. The frame body portion 51 holds the opaque isolating portion 52, and is sleeved at least partially over the inner framework 4. The opaque isolating portion 52 and the frame body portion 51 cover the detection unit 3 and the support 42. The isolating portion 52 of the outer framework 5 extends over the support 42 of the inner framework 4 and the detection unit 3, and is formed with an aperture 53. The aperture 53 allows passage of the light reflected by the object under detection 9 and passing through the transparent touch platform 62 to reach and pass through the imaging lens 44. In this embodiment, the outer framework 5 is opaque.

The outer cover 6 is made of a transparent material, covers the outer framework 5, and includes a transparent touch platform 62. The outer cover 6 also covers the circuit board 1 and cooperates with the circuit board 1 to define an accommodation space 61. The light emitting component 2, the detection unit 3, the light guiding component 41, the imaging lens 44, and the outer framework 5 are disposed in the accommodation space 61. The transparent touch platform 62 is disposed above the imaging lens 44, and has a touch surface 63 for movement of the object under detection 9 thereon.

The flexible printed circuit board 7 is connected electrically to the circuit board 1 for being connected conveniently to a connector of an external circuit.

Light emitted from the light emitting component 2 is reflected by the concave reflective mirror 411 to pass through the transparent touch platform 62, and is then reflected by the object under detection 9 to again pass through the transparent touch platform 62 and further through the aperture 53 and the imaging lens 44, after which the light reflected by the object under detection 9 is projected onto the detection unit 3. The detection unit 3 determines a displacement distance and direction of the object under detection 9 relative to the touch surface 63 of the transparent touch platform 62. The detection unit 3 subsequently outputs a signal corresponding to the determined displacement distance and direction of the object under detection 9 through the flexible printed circuit board 7.

In greater detail, the light reflected by the object under detection 9 is projected onto the image sensor 31 which forms corresponding images and transmits the images to the displacement calculation circuit 32. The displacement calculation circuit 32 determines the displacement distance and direction of the object under detection 9 relative to the touch surface 63 of the transparent touch platform 62 from the received images, and output a corresponding signal.

Referring to FIG. 4, the concave reflective mirror 411 is designed for reflecting the light from the light emitting component 2. The concave reflective mirror 411 enhances light utilization efficiency and saves electricity, and cooperates with other elements of the optical pointing device of this invention to allow for a small overall size thereof, thereby allowing miniaturization of a portable electronic device, such as a cell phone, in which the optical pointing device is utilized. Furthermore, the concave reflective mirror 411 of the light guiding component 41 has a concave surface that is part of an elliptic surface. The light emitting component 2 is located at a focal point of the elliptic surface. The transparent touch platform 62 is located above the imaging lens 44 and at another focal point of the elliptic surface. These configurations can further enhance the light utilization efficiency of the optical pointing device of this invention.

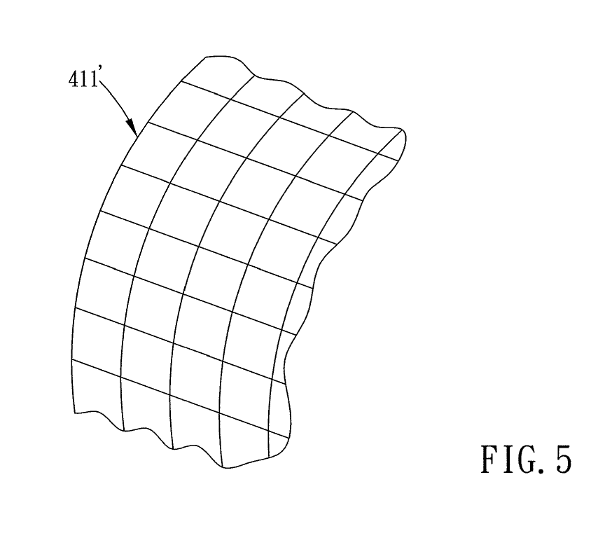

As shown in FIG. 5, the concave reflective mirror 411 of the light guiding component 41 may include a plurality of small concave mirrors 411′ which are assembled together for increasing the light utilization efficiency and light uniformity of the optical pointing device of this invention.

In addition, a filter (not shown) designed to allow passage of the light emitted from the light emitting component 2 can be disposed along an optical path between the transparent touch platform 62 and the detection unit 3, such that the light from the light emitting component 2 can pass therethrough and ambient light with other wavelengths can be filtered out for improving optical signal quality. The filter may be disposed between the transparent touch platform 62 and the imaging lens 44 or between the imaging lens 44 and the detection unit 3. Alternatively, the transparent touch platform 62 and/or the imaging lens 44 can be fabricated by using materials for achieving a similar filtering effect.

In this embodiment, the inner framework 4, the outer framework 5, and the outer cover 6 can be fabricated through an injection molding process. After the injection molding process, the concave reflective mirror 411 (or, in this embodiment, the small concave mirrors 411′ of the concave reflective mirror 411) can be formed on the concave surface of the light guiding component 41, which is coated with a metal layer. During assembly, the light emitting component 2 and the detection unit 3 are first provided on the circuit board 1, such as by a soldering process, in a manner electrically coupled to the flexible printed circuit board 7, then the inner framework 4 and the outer framework 5 are mounted on the circuit board 1. Finally, these components are covered by the outer cover 6.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An optical pointing device comprising:
a circuit board;
a light emitting component that is disposed on and connected electrically to said circuit board;
a detection unit that is disposed on and connected electrically to said circuit board, and that is spaced part from said light emitting component;
a light guiding component that is adjacent to said light emitting component and includes a concave reflective mirror;
an imaging lens that is disposed above said detect ion unit; and
a transparent touch platform that is disposed above said imaging lens and has a touch surface for movement of an object under detection thereon;
wherein light emitted from said light emitting component is reflected by said concave reflective mirror to pass through said transparent touch platform, and is then reflected by the object under detection to again pass through said transparent touch platform and further through said imaging lens, after which the light reflected by the object under detection is projected onto said detection unit, said detection unit determining a displacement distance and direction of the object under detection relative to said touch surface of said transparent touch platform.

2. The optical pointing device as claimed in claim 1, further comprising an outer cover, said outer cover including said transparent touch platform, said outer cover covering said circuit board and cooperating with said circuit board to define an accommodation space, said light emitting component, said detection unit, said light guiding component and said imaging lens being disposed in said accommodation space.

3. The optical pointing device as claimed in claim 1, further comprising an inner framework, said inner framework including said light guiding component, a support which holds said imaging lens, and a connecting arm which interconnects said light guiding component and said support in such a manner that a gap is formed therebetween for passage of the light reflected by said concave reflective mirror of said light guiding component toward said transparent touch platform.

4. The optical pointing device as claimed in claim 3, wherein said inner framework includes a pair of said connecting arms extending from two opposite sides of said support and connected to said light guiding component, said gap being defined by said support, said connecting arms, and said light guiding component.

5. The optical pointing device as claimed in claim 3, further comprising an outer framework disposed in said accommodation space, said outer framework including an opaque isolating portion disposed between said light emitting component and said detection unit for preventing light emitted from said light emitting component from being delivered directly to said detection unit.

6. The optical pointing device as claimed in claim 5, wherein said isolating portion of said outer framework extends over said support of said inner framework and said detection unit, and is formed with an aperture, said aperture allowing passage of the light reflected by the object under detection and passed through said transparent touch platform to reach and pass through said imaging lens.

7. The optical pointing device as claimed in claim 5, wherein said outer framework further includes a frame body portion that holds said opaque isolating portion and that is sleeved at least partially over said inner framework, said opaque isolating portion and said frame body portion covering said detection unit and said support.

8. The optical pointing device as claimed in claim 7, wherein said outer cover covers said outer framework.

9. The optical pointing device as claimed in claim 1, further comprising a flexible printed circuit board connected electrically to said circuit board, said detection unit outputting a signal corresponding to the determined displacement distance and direction of the object under detection through said flexible printed circuit board.

10. The optical pointing device as claimed in claim 1, wherein said concave reflective mirror of said light guiding component has a concave surface that is part of an elliptic surface, said light emitting component being located at a focal point of the elliptic surface, said transparent touch platform being located above said imaging lens and at another focal point of the elliptic surface.

11. The optical pointing device as claimed in claim 1, wherein said concave reflective mirror of said light guiding component includes a plurality of small concave mirrors which are assembled together.

12. The optical pointing device as claimed in claim 1, wherein said detection unit includes an image sensor and a displacement calculation circuit, the light reflected by the object under detection being projected onto said image sensor which forms corresponding images and transmits the images to said displacement calculation circuit, said displacement calculation circuit determining the displacement distance and direction of the object under detection relative to said touch surface of said transparent touch platform from the received images.

13. The optical pointing device as claimed in claim 1, wherein at least one of said transparent touch platform and said imaging lens is fabricated using a material which can filter out ambient light which has a wavelength different from a main wavelength of the light emitted by said light emitting component.
